(19) United States
(12) Patent Application Publication
(10) Pub. No.: US 2023/0307154 A1
(43) Pub. Date: Sep. 28, 2023

(54) ALUMINUM-CARBON METAL MATRIX COMPOSITES FOR BUSBARS

(71) Applicant: YAZAKI CORPORATION, Tokyo (JP)

(72) Inventors: Markus Boehm, Nuernberg (DE); Kyle James Deane, Camarillo, CA (US); Jeyakumar Manickaraj, Newbury Park, CA (US); Stefan Maat, Camarillo, CA (US); Douglas Meyers, Los Angeles, CA (US)

(21) Appl. No.: 18/319,412

(22) Filed: May 17, 2023

Related U.S. Application Data
(63) Continuation of application No. PCT/US2021/072493, filed on Nov. 18, 2021.
(60) Provisional application No. 63/115,861, filed on Nov. 19, 2020.

(51) Int. Cl. H01B 1/02

(52) U.S. Cl. CPC H01B 1/023; H01B 5/02

(57) ABSTRACT

A busbar for electrical power distribution applications. The busbar includes an aluminum (Al) metal matrix composite (MMC) having nanoscale carbon particles (e.g., carbon nanotubes). In one example, the concentration of the nanoscale carbon particles is in a range of 0.01 to 2 percent weight (wt %). The nanoscale carbon particles are evenly distributed throughout an entirety of the Al-MMC.

### CROSS-REFERENCE TO RELATED APPLICATIONS

This application claims priority to and is a 35 U.S.C. § 111(a) continuation of PCT International Application No. PCT/US2021/072493 filed on Nov. 18, 2021, incorporated herein by reference in its entirety, which claims priority to, and the benefit of, U.S. Provisional Application No. 63/115,861 filed on Nov. 19, 2020, incorporated herein by reference in its entirety. Priority is claimed to each of the foregoing applications.

### TECHNICAL FIELD

The disclosed teachings relate to metal composites for busbar applications.

### BACKGROUND

In electric power distribution, busbars are metallic strips or bars, typically housed inside switchgears, panel boards, and busway enclosures for local high current power distribution. They are also used to connect high voltage equipment at electrical switchyards, and low voltage equipment in battery banks. They are generally uninsulated and have sufficient stiffness to be supported in air by insulated pillars. These features allow sufficient cooling of busbar conductors, and the ability to tap into a conductor at various points without creating a new joint.

The material composition and cross-sectional size of a busbar determines a maximum amount of current that can be safely carried. Busbars can have a cross-sectional area of as small as 10 square millimeters (mm²), but electrical substations may use metal tubes about 50 mm in diameter (or about 2,000 mm²) or more as busbars.

Busbars are produced in a variety of shapes, such as flat strips, solid bars, or rods, and are typically composed of copper, brass, or aluminum (Al). Some of these shapes allow heat to dissipate more efficiently due to their high surface area to cross-sectional area ratio. The skin effect makes 50-60 Hz AC busbars inefficient when greater than about 8 mm thick; accordingly, hollow or flat shapes are prevalent in higher-current applications. A hollow section also has higher stiffness than a solid rod of equivalent current-carrying capacity, which allows for a greater span between busbar supports in outdoor electrical applications.

### BRIEF DESCRIPTION OF THE DRAWINGS

One or more embodiments of the present disclosure are illustrated by way of example and not limitation in the Figures of the accompanying drawings, in which like references indicate similar elements.

FIG. 1 include images of commercially available busbars.

FIG. 2 is a graph that shows effects of adding alloying elements on the mechanical strength and electrical conductivity of aluminum.

FIG. 3 is a flowchart that illustrates a process for achieving an even distribution of nanoscale carbon particles in a metal matrix composite (MMC).

FIG. 4 is a graph that shows beneficial physical properties of aluminum (Al) 0.5 percent by weight (wt %) carbon nanotubes (CNT) in an as-extruded condition, compared with the properties of pure aluminum.

FIG. 5 is a graph that shows results of creep testing performed on an Al-0.5 wt % CNT busbar and on an A6063-T5 busbar for comparison.

FIG. 6 is a graph that shows how cold working affects the strength of Al-0.5 wt % CNT MMC wire compared with that of pure Al wire.

FIG. 7 includes graphs that show ultimate tensile strength (UTS) of Al-0.5 wt % CNT wires with different amounts of cold work.

FIG. 8 includes images that show microstructural differences between Al-0.5 wt % CNT MMCs, before and after CNT distribution is improved by extrusion processing.

FIG. 9 is a set of graphs that show the statistical distribution of CNT aggregate size and number in Al-0.5 wt % CNT MMCs, before and after CNT distribution is improved by extrusion processing.

FIG. 10 includes images showing that bending behavior can also benefit from improved dispersion of CNTs in Al-CNT MMC busbars.

FIG. 11 depicts how the quality of CNT distribution in drawn Al-0.5 wt % CNT MMC wire affects heat treatment-induced grain growth.

FIG. 12 includes graphs that show UTS of Al-0.5 wt % CNT wires with differing CNT concentrations.

### DETAILED DESCRIPTION OF THE INVENTION

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts that are not particularly addressed herein. It should be understood that these concepts and applications fall within the scope of the disclosure and the accompanying embodiments.

### Busbar Applications

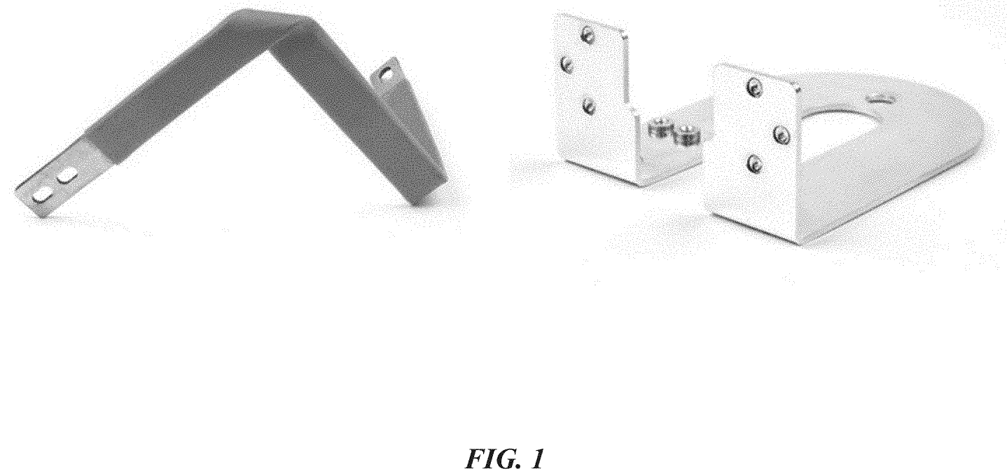

In electric power distribution, a busbar is a metal strip or bar for local high current power distribution. FIG. 1 includes images of examples of commercially available copper (Cu) busbars. The marine, transportation, telecommunications, utility and power generation industries include applications of busbars. The automotive industry can also include a variety of busbars to provide a robust method of distributing high current electricity. These industries can benefit by replacing Cu busbars with aluminum (Al) to reduce weight and cost. For example, in the automotive industry, with rising interest in electric vehicles (EV) or hybrid electric vehicles (HEV), power distribution requirements and, consequently, the quantity of busbars required in these vehicles has risen significantly. As busbars are traditionally made from Cu, the increase in busbar use has a negative impact on vehicle weight. With a density and electrical conductivity of about 30% and about 60% that of Cu, respectively, Al can achieve similar power distribution with a weight savings of about 50% over Cu. Moreover, while the cost of raw materials and industrial process will fluctuate, Al has historically been much less expensive than Cu. Thus, because Al conductors intended for the same electrical requirements are both lighter and less expensive than Cu conductors, substituting Cu busbars with Al busbars in automotive applications could offset the rising weight and costs while still satisfying electrical power requirements.

Efficiently mounting and connecting electrical components in vehicles is of growing importance and, for this purpose, wires, cables, and busbars are commercially used to distribute power to the vehicles' various subsystems. In an HEV/EV battery module connection assembly, connectors preferably have high strength, conductivity (e.g., thermal, electrical) and thermal stability. Standard current carrying capacity for Al is around 0.7 A/mm², which is sufficient for use in connecting the battery module in HEVs/EVs. The electrical power requirements of HEVs/EVs continue to increase each year, and therefore the need for efficient connections is also increasing. However, merely increasing the number or cross-sectional size of busbars to meet the rising demand goes against goals of reducing weight and costs.

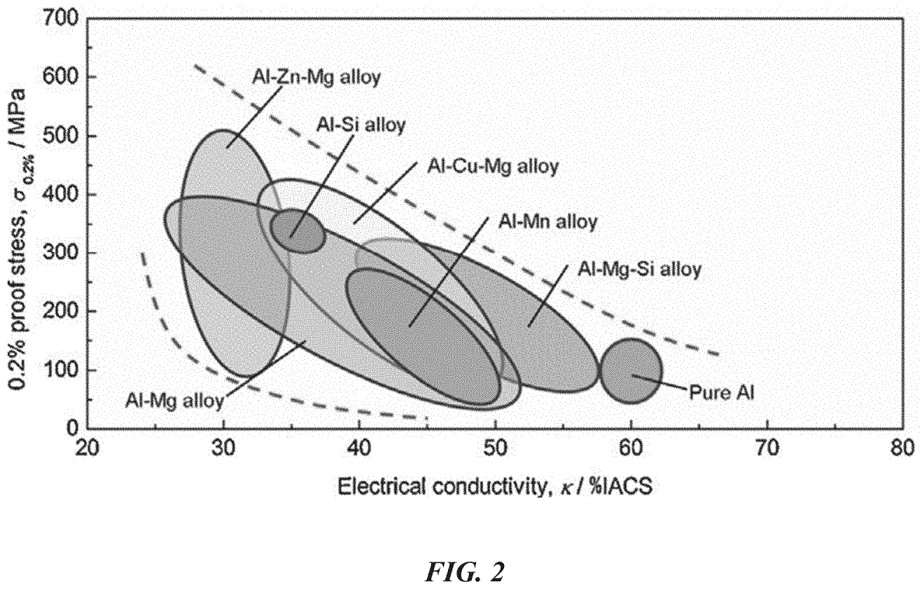

Commercially available Al alloys are not ideal substitutes for Cu in busbar applications, as they do not possess the necessary combination of properties such as strength, electrical conductivity, creep resistance, thermal stability, etc. For example, FIG. 2 shows that the strength of Al alloys can be increased by adding alloying elements. However, these additions come at the cost of decreased electrical conductivity, as any elements in solution with the solid a Al matrix phase serve to act as additional electron scattering sites (J. Tokutomi et al, CIRP Annals—Manufacturing Technology 64 (2015) 257-260). In addition, alloying elements in commercial Al alloys have relatively high mobility in the a Al phase, which results in a decrease in strength due to over-aging if they are held at elevated temperatures. This tendency of over-aging can also have a negative effect on elevated temperature creep resistance of typical Al alloys.

### Aluminum Carbon Metal Matrix Composites for Electrical Busbar Applications

The disclosed embodiments include busbars and related products made of an Al-based metal matrix composite (MMC) comprising particles that are not soluble in the α Al phase, which offer a significant amount of strengthening and creep resistance. More particularly, the disclosed technology relates to aluminum carbon (Al-C) MMCs for electrical busbar applications. In one example, an MMC includes an Al matrix with carbon nanotubes (CNTs) distributed therein. A CNT is a molecular-scale structure consisting of carbon (C) atoms arranged in one or more cylindrical layers (e.g., single-walled, multi-walled), joined by covalent bonds in a hexagonal tiling or other geometric pattern within each layer, so as to form a hollow tube having a diameter of up to a few hundred nanometers. Carbon nanotubes are considered to be allotropes of carbon, intermediate between fullerene cages and flat graphene sheets (as in graphite).

An Al-C MMC has many advantages for electrical busbar applications. The disclosed MMCs demonstrate desirable strength, thermal stability, and creep resistance while maintaining electrical conductivities near that of pure aluminum. Use of MMCs in busbar applications could allow for improved ampacity for a given busbar cross sectional area, as the high thermal stability can allow for increased operational temperature. This could enable weight reduction through a decrease of busbar dimensions, or if the busbar size remains constant, it could allow for a higher peak current draw without causing structural or performance issues. In addition, the creep resistance of the MMC could help reduce complications associated with connections between busbars and other electrical components. While these busbars could be used in any industry, emphasis is placed in this disclosure on the potential benefits for the automotive industry.

The busbar can have an electrical conductivity greater than 50% International Annealed Copper Standard (IACS), an ultimate tensile strength (UTS) greater than 80 MPa, and an elongation greater than 10%. In one example, a busbar has a conductivity greater than 50%, or greater than 55%, or greater than 58% IACS, a UTS greater than 120 MPa, and an elongation greater than 30%. However, the busbar can have properties in other ranges. In another example, the busbar has a conductivity greater than 50%, or greater than 55%, or greater than 58% IACS, a UTS greater than 200 MPa, and an elongation greater than 1%. In another example, the busbar has a conductivity greater than 50%, or greater than 55%, or greater than 58% IACS, a UTS greater than 300 MPa, and an elongation greater than 3%.

The Al-MMC material can be pure Al, or it can be an Al alloy containing metallic elements other than Al. Preferably, the Al matrix is pure Al or an Al alloy having an electrical conductivity of at least 50% IACS, for example, wrought alloys of the 1XXX series, having a minimum Al content of 99%. Al alloys in the other wrought alloy series from 2XXX-7XXX may be suitable, provided they have conductivity of 50% IACS or above. Al alloys of other non-commercial compositions may also be suitable. For example, an aluminum-scandium (Al—Sc—X) alloy having Sc and optionally other elements such as zirconium (Zr), erbium (Er), and/or ytterbium (Yb), having conductivity of greater than 50% IACS, is suitable. As used herein, the terms “Al-C,” “Al-CNT,” and “Al-CNT MMC” may refer to an MMC of pure Al or an Al alloy, with C or CNT particles distributed in the matrix.

In a soft condition, such as after extrusion at high temperatures, a 2×20 mm rectangular Al-0.5 wt % CNT MMC busbar can have a desirable combination of tensile and electrical properties, with UTS of about 120 MPa, elongation of about 30%, and electrical conductivity of greater than 50%, or greater than 55%, or greater than 58% IACS. These examples have improved creep behavior (e.g., minimal creep after 500 hours (hr) at 80% of yield strength and 150° C.). Moreover, cracking is not observed in 180 degree flatwise bend tests of Al-0.5 wt % CNT busbars that have CNT more evenly distributed throughout the matrix of the MMC.

In some embodiments, cold working the Al-0.5 wt % CNT MMC has minimal impact on electrical conductivity and the tensile strength can increase significantly while the elongation can decrease. A greater UTS of about 335 MPa can be observed, although there is no indication that this value is an upper limit to the strength that can be achieved with the disclosed method. The elongation remains at about 4% for all cold worked examples. The strength that is achieved through cold working can be thermally stable, as described for material type AT4 in International Standard IEC 62004 “Thermal-resistant aluminium alloy wire for overhead line conductor,” after an initial stress relaxation heat treatment. According to the standard, to qualify as type AT4, an Al alloy wire must retain 90% of its initial tensile strength after undergoing heat treatment at 310° C. for 400 hours, or at 400° C. for 1 hour.

For example, for an Al-0.5 wt % CNT MMC with an initial as-drawn tensile strength of 335 MPa, heat treatment at 325° C. for 1 hr will typically reduce the strength by about 30 MPa to a thermally stable condition, e.g., with a UTS of ˜305 MPa. Subsequently, heat treatment at either 310° C. for 400 hours or at 400° C. for 1 hour will result in a reduction in UTS of less than 10%. Therefore, heat treated material meets the requirements for type AT4 according to the IEC 62004 standard.

A significant factor in the effectiveness of Al-C MMC is the distribution of the nanoscale carbon particles within the MMC. For example, if CNTs are present in an Al matrix as aggregates greater than, for example, 10 microns wide, a large fraction of the CNTs in an Al-CNT MMC can be wasted in terms of not contributing to an increase in the strength of the matrix. The fabrication of Al-CNT MMCs with an even distribution of CNT, and in a manner conducive to large scale manufacturing, remains a major hurdle to the wide-scale application of these materials. With the solution disclosed herein, CNT distribution and therefore the properties of an Al-CNT MMC with an initially poor CNT distribution are improved by solid-state deformation in accordance with extrusion processing, ECAP, etc. Examples described herein have improved strength, thermal stability, creep resistance, and bending behavior.

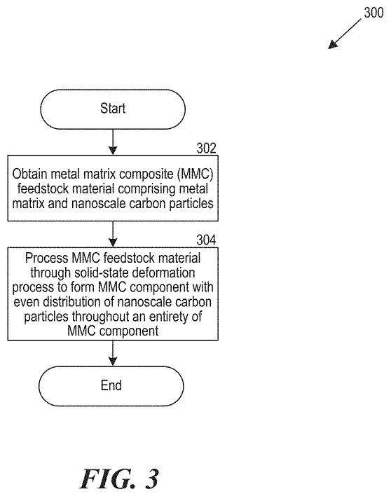

FIG. 3 is a flowchart that illustrates a process 300 for achieving an even distribution of nanoscale carbon particles in an MMC (e.g., an Al-C MMC). At 302, an MMC feedstock material is prepared (e.g., Al-MMC feedstock), which comprises a metal matrix and nanoscale carbon particles. Examples of the feedstock material include Al-C rods, bars, granules, or compacted powder billets. At 304, the MMC feedstock material is processed through a solid-state deformation process to form an MMC component with even distribution of the nanoscale carbon particles. As such, the MMC component can have an even distribution of the nanoscale carbon particles at a concentration range of 0.01 to 2 wt %, for example. Examples of the solid-state deformation process include an extrusion process or an equal channel angular pressing (ECAP) process. The MMC feedstock material can pass through the solid-state deformation process multiple times to further improve homogeneity.

In general, a small addition of well-distributed nanoscale carbon particles (e.g., CNTs) to Al provides for an increased tensile strength while maintaining a substantially similar electrical conductivity, modulus of elasticity, and coefficient of thermal expansion compared to substantially pure aluminum. Nanoscale particles can be broadly defined as particles that have at least one critical dimension less than 100 nanometers and possess unique optical, magnetic, or electrical properties. Nanoscale carbon particles are nanoscale particles composed primarily of carbon, such as CNT, graphene, fullerenes, nanodiamonds, and the like.

Further, in general, an Al-CNT MMC product gains its tensile strength through work and dispersion hardening. For example, during cold working by rolling and/or drawing of extruded material to a final size, the grain structure is refined, and CNT disperses more evenly in the matrix. While the tensile strength of Al-CNT increases with CNT content, the electrical conductivity slightly decreases. From that perspective, a preferred concentration is between about 0.01 to 2 weight percent (wt %), such as between 0.1 to 1 wt %, or between 0.2 to 0.8 wt %, or between 0.25 to 0.75 wt %, or between 0.4 to 0.6 wt %, or about 0.5 wt % CNT, with which the MMC maintains an electrical conductivity of greater than 50%, or greater than 55%, or greater than 58% IACS, while substantial gains in UTS can be achieved.

In the case of an Al-CNT MMC rod or wire, the effect of cold work through drawing from an initial extruded diameter to a final diameter is illustrated by the following relationship:

$${D}_{i} = {D}_{f} * exp ( \frac{UTS - A}{B} )$$

where A and B are constants that depend on an amount of CNT. This equation can be used to calculate the initial extrusion diameter, Dᵢ of an Al-CNT rod that is needed in order to achieve a desired UTS and final diameter, D_{f} of an extruded and drawn wire. For a matrix consisting of 1070 Aluminum (Al99.7) combined with a 0.5 wt % CNT, constants A and B were found to be about 145 and about 60, respectively.

In particular, the electrical conductivity of conductor grade Al such as AA 1350 is 61.2 to 61.8% IACS, and its strength is low as compared to Cu. As described above, the addition of alloying elements to Al increases the strength (e.g., 2xxx, 5xxx, 6xxx and 7xxx series alloys) but typically reduces the conductivity. The thermal stability of Al alloys is low, as the strengthening particles used in commercially available alloys have relatively high mobility in the Al matrix. Because of this, Al alloys are typically not used for applications that see temperatures greater than about 150° C. However, as indicated above, Al-CNT MMCs provide high mechanical strength and thermal stability for temperatures greater than about 150° C. without a significant loss of electrical conductivity.

The disclosed technology can thus provide advancements over pure Al and Al alloy busbars with improved electrical conductivity, strength, usage temperatures, and creep resistance, particularly in the automotive industry. Examples in the automotive industry that can benefit from the disclosed technology include busbars that connect individual cells in a battery pack, connect multiple battery packs, and connect battery packs to motor inverters and other electrical components. Some busbars are used in parts of the vehicle that see elevated temperatures. The busbars can be simple straight connections between two or more components, or they can have complex geometries to navigate through tightly packed areas of the vehicle. These busbars are typically tin-plated copper and are good examples of busbars that could be replaced with the Al-CNT MMCs discussed herein. Because of this, ideal Al MMCs for busbars are capable of both being formed into complex shapes without forming cracks and being strong enough to maintain those shapes throughout the life cycle of the busbar.

Al MMCs that are reinforced with CNTs provide high specific strength and have excellent thermal/electrical properties. The quantity of CNT used and its distribution in the Al matrix are key parameters to reach a maximum strength of the Al-CNT composite. For example, it has been observed that an MMC with a lower concentration of CNT (0.1 wt %) and uniform dispersion in the matrix, can have higher strength than similarly-prepared MMCs with relatively higher concentrations of CNT (0.25-1.0 wt %) but with poor dispersion and large aggregates in the matrix.

To produce an Al busbar with desirable strength, thermal stability, and creep resistance, without significantly reducing the electrical conductivity below that of pure Al, it is beneficial to create a fine dispersion of strengthening particles surrounded by an a Al matrix that is relatively devoid of solute atoms. To achieve this result, MMC additions that have no significant solubility in a-Al should be used. As carbon has no reported solid solubility in Al and can be produced in several nanoscale structures, it is an ideal candidate as an addition for Al-based MMC busbars for electrical power distribution applications. Examples of suitable nanoscale particles in addition to CNTs include graphene nanoplatelets (GNPs), fullerenes (e.g., form of carbon having a large spheroidal molecule consisting of a hollow cage of atoms), and nanodiamonds (e.g., a diamond particle with dimensions of only a few nanometers).

To achieve the greatest benefit from nanoscale carbon particle additions, an even distribution of the particles throughout the MMC is preferred. Depending on the desired scale of production and the form of carbon used, an even distribution can be accomplished in several ways. For example, adding carbon particles to an Al melt and casting the MMC is one approach, although care must be taken to avoid segregation or burning of the carbon addition. A second method is to use powder metallurgy techniques to evenly mix and sinter Al and nanoscale carbon powders together into a solid billet. A third method involves mechanical stirring of nanoscale carbon particles into an Al matrix through solid state processing techniques such as friction stir processing, ECAP, extrusion, etc.

The resulting busbar has a carbon particle (e.g., CNT) concentration that is evenly distributed over the entire volume of the busbar. That is, there are no significant irregular voids or irregular empty spaces between carbon particles, the carbon particles are not aggregated (or any aggregations are negligible), and there are no areas of higher or lower concentrations of carbon particles throughout the entire busbar. The amount of carbon particles in a matrix is essentially the same in all portions of the matrix volume, i.e., there are no portions within the Al-MMC composite that have a distinct difference, i.e., more than 20%, 10%, or preferably 5% difference, in carbon particle concentration from any other portion.

In one example, the resulting busbar has a uniform density that is non-porous. For example, the density may deviate by 2% at most from a theoretical composite density, which can be calculated based on the volume of the material, the relative amounts of Al and carbon particles, and their respective densities. The even carbon particle concentration of a sample Al-C MMC provides consistent and uniform characteristics such as uniform conductance throughout the entire volume of the busbar. The uniform distribution of carbon particles in a sample Al-C MMC busbar can be verified by high resolution microscopy.

Whichever technique is used to produce the Al-C MMCs, the final amount of residual stress from processing will have an impact on the resulting strength and elongation of the MMC. For busbar applications that require significant elongation, such as those requiring bending of the busbar to achieve a specific geometry for installation, care should be taken to achieve a final condition that is relatively free of residual stresses. One method to achieve a final condition suitable for this application is through annealing of a busbar at high temperatures to relieve residual stresses after any necessary cold working procedures are performed. Another method is to initially produce the busbar with the desired final dimensions and geometry using a process that runs at elevated temperatures (e.g., casting, extrusion) to limit an occurrence of residual stresses. If a higher strength is desired and the elongation is of less importance, residual stresses through the application of cold work or the like are a viable way to increase the strength.

### Production Details

The disclosed embodiments include a method to produce Al MMC busbars containing small amounts e.g., (0.01-2 wt %) of nanostructure additions such as CNTs, GNPs, fullerenes, and/or nanodiamonds. Production of these busbars can be accomplished with several processing techniques, including some or all of the following processes.

Initial preparation of the Al-C MMC busbar could be made by a casting process. However, there could be challenges associated with this method. For example, a primary concern is that the carbon may separate from the molten Al and float to the surface of the melt. Furthermore, the nanoscale carbon particle additions will burn at liquid Al temperatures if oxygen is available. One offsetting factor to the latter point is that liquid Al aggressively forms Al₂O₃ in the presence of O₂, so the danger of burning the carbon additions is reduced.

However, aluminum carbide may be formed instead, which can significantly degrade the mechanical and electrical properties of the Al-C MMC.

Powder metallurgy techniques are currently a common way to produce Al-C MMC material. This approach typically involves some combination of mixing Al and nanoscale carbon powders together, ball milling the powders, compacting the powder mixture, and/or sintering the material into a high-density product. Powders can be mixed in a dry condition or as part of a slurry, in which case the solvent of the slurry should be evaporated before compaction/sintering. Care should be taken when handling fine powders as they may be combustible, depending on the chemical composition. For example, according to The Aluminum Association and National Fire Protection Agency (NFPA) standard #484 “Standard for Combustible Metals, Metal Powders, and Metal Dusts,” aluminum powders with a particle size of 40 mesh (420 micrometers) or smaller can present a fire or explosion hazard.

Extrusion can be used to accomplish several objectives in the production of Al-C MMC busbars. The most basic of these objectives is to produce specific shapes and dimensions of an extruded product. These dimensions may coincide with the target final dimensions for the busbar in the case that more value is placed on elongation rather than strength of the busbar, or the dimensions may be oversized in the case that cold working (rolling, etc.) is employed to increase the strength while decreasing the cross-sectional area down to the target busbar dimensions.

In addition to geometric objectives such as size and shape, extrusion with the proper tooling and parameters can be used to increase homogeneity of carbon additions in poorly homogenized Al-C feedstock that was produced by other means. Using this technique to increase the homogeneity of Al-C MMCs can result in a significant improvement of performance in terms of strength, thermal stability, etc. Depending on the extrusion process used, feedstock material can be in the form of Al-C rods, bars, granules, compacted powder billets, etc., and multiple passes through the extrusion process can be employed to further improve homogeneity if needed.

Rolling and related processes can be performed on Al-C MMCs to achieve the target size and dimensions for a busbar specification. This process can be performed at room temperature but it can also be performed at elevated temperatures (e.g., hot rolling) to relieve internal stresses if high elongation in the final busbar is desired, as the residual stresses from cold working the busbar will generally reduce elongation and increase strength. Alternatively to hot rolling, a heat treatment can be applied after cold rolling as a method to relieve residual stresses after production.

Bending and forming can be performed on a busbar to achieve useful shapes for use within an automobile. Bending can include flatwise bending, edgewise bending, twisting, etc. The ease of bending and forming processes will be dependent on the structure and amount of carbon included in the MMC, as well as the grain size and amount of residual stress present in the busbar at the time of bending. For optimal bending capability of any specific Al-C MMC, care should be taken to minimize residual stresses at the time of bending, by either avoiding cold working by fabricating the MMC as a near net shape object, or by annealing at a high enough temperature to relieve stresses accumulated during cold working procedures. However, if strengthening provided by the residual stresses is necessary for the properties of a final busbar application, minor bending can still be performed with little or no annealing. When setting up a new busbar bending application with Al-C MMC materials, it can be important to investigate the resulting bends for cracks and, if found, adjust the amount of annealing to relieve additional stresses and increase the elongation of the material, so that such cracking is avoided.

### Examples of Al-CNT Properties without Significant Residual Stress

### Strength and Elongation Behavior

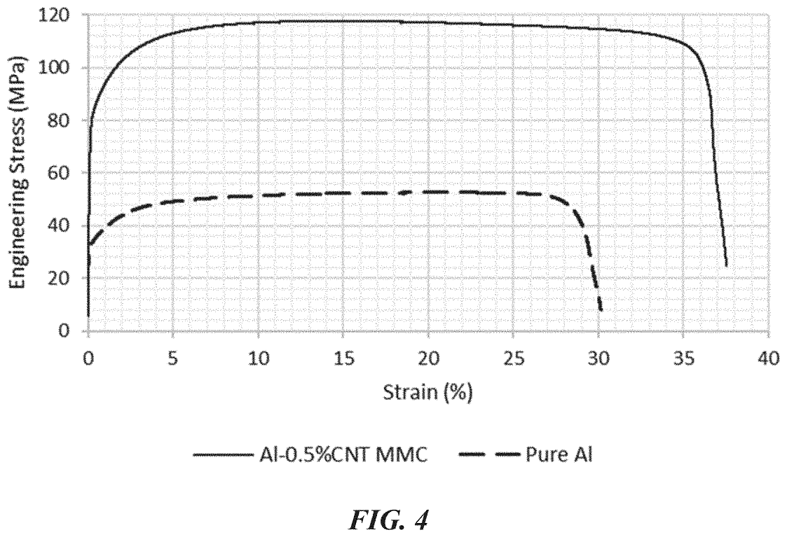

FIG. 4 is a graph that shows beneficial physical properties of Al-0.5 wt % CNT in an as-extruded condition, compared with the properties of pure Al in as-extruded condition. More specifically, FIG. 4 includes a tensile test that shows the properties of an as-extruded 2×20 mm rectangular Al-0.5 wt % CNT busbar, with UTS≅120 MPa and elongation≅35%. The as-extruded pure Al busbar, in contrast, shows UTS≅52 MPa and elongation≅27%. As extrusion of the Al-CNT 2×20 mm rectangular busbar is performed at sufficiently elevated temperature to relieve stress, the MMC has greater elongation and lower strength than a material of similar composition after it undergoes cold working. In this condition, with a UTS of about 120 MPa and an elongation of about 30%, this material is a good fit for busbar applications that need to be formed into complex shapes, such as bending with small internal radii and edgewise (i.e., hard-way) bending. Although the strength of this example is lower than attainable for cold-worked Al-C MMC busbars, a UTS of about 120 MPa is still higher than many common Al conductors in soft condition (e.g., Al-1350-O with UTS≈60 MPa).

### Electrical Conductivity

In one example, conductivity of as-extruded Al-0.5 wt % CNT MMC, measured on round wire samples produced in several different production runs, has been measured to be consistently greater than 58% IACS.

### Creep Behavior

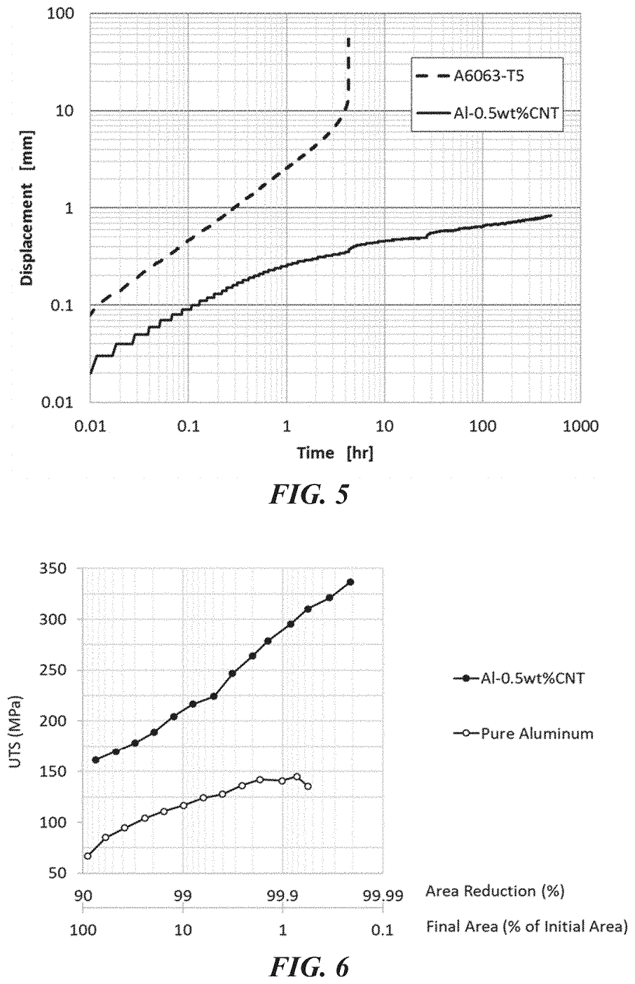

FIG. 5 is a graph that shows results of creep testing performed on an Al-0.5 wt % CNT busbar and on an Al alloy A6063-T5 busbar for comparison. FIG. 5 more specifically shows initial creep testing results for an Al-0.5 wt % CNT busbar, compared with results for an A6063-T5 busbar. As both tests were performed at 150° C. and with samples loaded to 80% of their room-temperature yield strength, the Al-CNT MMC busbar is shown to have improved creep properties. In one example, tertiary creep was not reached in Al-0.5 wt % CNT before the test was aborted at 500 hours to avoid excessive costs.

Al-0.5 wt % CNT busbars of the disclosure can show total displacement of less than about 5%, or less than 4%, or less than 3%, or less than 2%, or less than 1%, when creep tested for 100 hours at 150° C. with a sample load equivalent to 80% of their room-temperature yield strength. In some embodiments, the MMC busbars can show total displacement of less than about 5%, or less than 4%, or less than 3%, or less than 2%, or less than 1%, when creep tested for 500 hours under the same conditions.

### Examples of Al-CNT Properties after Cold Working to Add Residual Stress

### Strength and Elongation Behavior

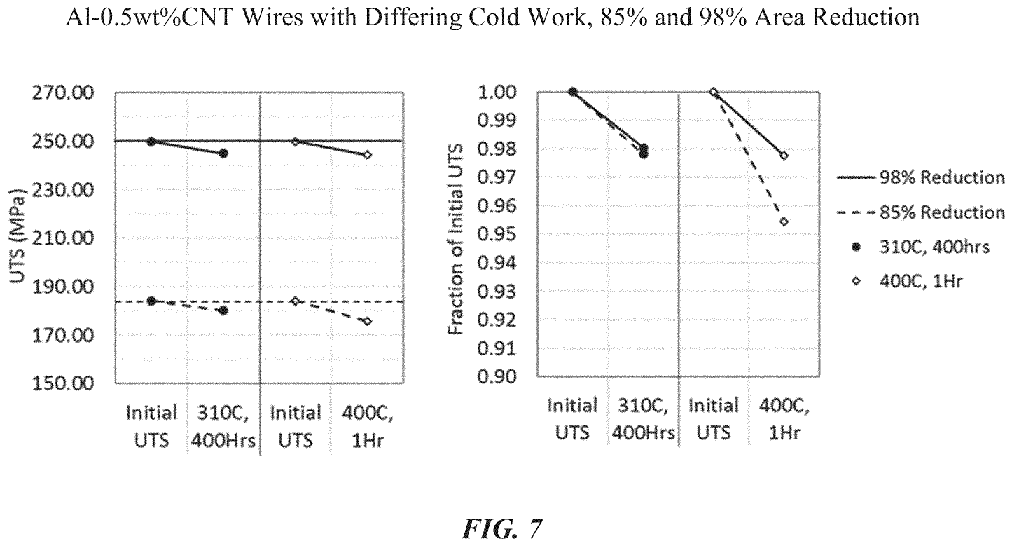

FIG. 6 is a graph that shows how cold working affects the strength of Al-0.5 wt % CNT MMC and Al round wires with reduction of cross-sectional area. More specifically, FIG. 6 shows plotted strength improvement with added cold work (wire drawing) for Al-0.5 wt % CNT and Al wires.

Based on these data, strengths as high as about 335 MPa were observed in the Al-0.5 wt % CNT MMC with a sufficient cold working area reduction. In contrast, pure Al wire initially increased in strength with cold work but at a somewhat reduced rate compared with the MMC. Moreover, the UTS of the pure Al wire reached a plateau at about 140 MPa. The elongation of the MMC stays consistent at 3-5% at all levels of cold working. This behavior does not change significantly when using this material for busbar applications rather than wire. As an alternative to area reduction, processes that apply internal stresses without changing the cross-sectional area (ECAP, etc.) could be used to increase strength in busbars that were initially produced at or near final target dimensions.

### Electrical Conductivity

In the example, electrical conductivity of drawn Al-CNT wires is observed to be in a similar range as wires before cold working is applied, at greater than 58% IACS.

### Thermal Stability

To assess the thermal stability of Al-C MMC products, heat treatments for AT4 classification (the highest classification of thermal stability described in specification IEC 62004, “Thermal-resistant aluminum alloy wire for overhead line conductor”) are applied to drawn Al-0.5 wt % CNT wires with two different levels of applied cold work (85% and 98% reduction in cross sectional area). To qualify for AT4 thermal stability, the wires must maintain over 90% of their UTS after being held at either 310° C. for 400 hours, or at 400° C. for 1 hour. FIG. 7 shows results of thermal stability testing on drawn Al-0.5 wt % CNT wires with two different levels of applied cold work (85 and 98% area reduction). As shown in FIG. 7, both of the drawn Al-0.5 wt % CNT wires passed this test easily, demonstrating thermal stability. Both wires maintain greater than 90% of their initial UTS after the heat treatments indicated, so they qualify for the AT4 classification, the highest level of thermal stability described in IEC 62004. This behavior is not specific to a wire and can be extended to busbar applications.

### Examples of the Benefits of Achieving Even Distribution of CNT in Al-CNT MMCs

### Achieving Even Distribution via a Compounding Extrusion Process

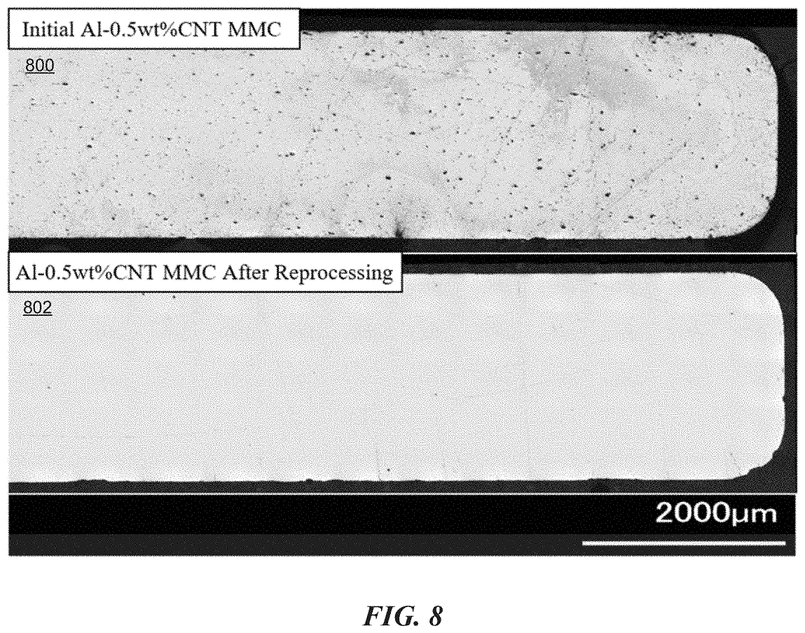

FIG. 8 includes images that show microstructural differences between two Al-0.5 wt % CNT MMCs: one before (CNT MMC 800) and one after (CNT MMC 802) even distribution of CNT is achieved by a compounding extrusion process. In the CNT MMC 800, many large CNT aggregates are clearly visible as black spots in the image. As such the CNT are largely separated from the matrix and do not contribute to improving the mechanical properties or thermal stability of the composite. After extrusion processing, in the CNT MMC 802, the number and size of these large visible black spots was reduced, while the measured carbon content remained consistent. From this and other observations, it is apparent that the large CNT aggregates are broken up and the CNT is distributed more evenly by the compounding extrusion process. This has several benefits for the properties of the CNT MMC, as discussed herein.

As shown, there is improvement in CNT distribution after applying a compounding extrusion process to the material. These cross-sectional micrographs show an Al-0.5 wt % CNT MMC busbar with high levels of undesirable CNT agglomeration before (CNT MMC 800) and low levels of undesirable CNT agglomeration after (CNT MMC 802) an added extrusion process to achieve an even distribution of CNT. The visible black spots are CNT aggregates, and the notable decrease in the size and number density of these spots after the compounding extrusion process indicates that the process broke up the aggregates and evenly distributed the CNT. Carbon concentration measurements verified that the carbon content of these MMCs remained unchanged by this processing and, as such, the same quantity of CNT is expected to be present in both.

In some embodiments, it is desirable in Al-CNT MMCs for the number of aggregates or particles to be minimized, and for existing aggregates to be as small as possible. The presence of fewer and smaller aggregates indicates that CNT are better distributed within the Al matrix, and can provide more benefit in terms of mechanical properties and thermal stability. It is possible to roughly correlate the statistical distribution of CNT aggregates in an Al-CNT MMC with the extent of improvement in these properties.

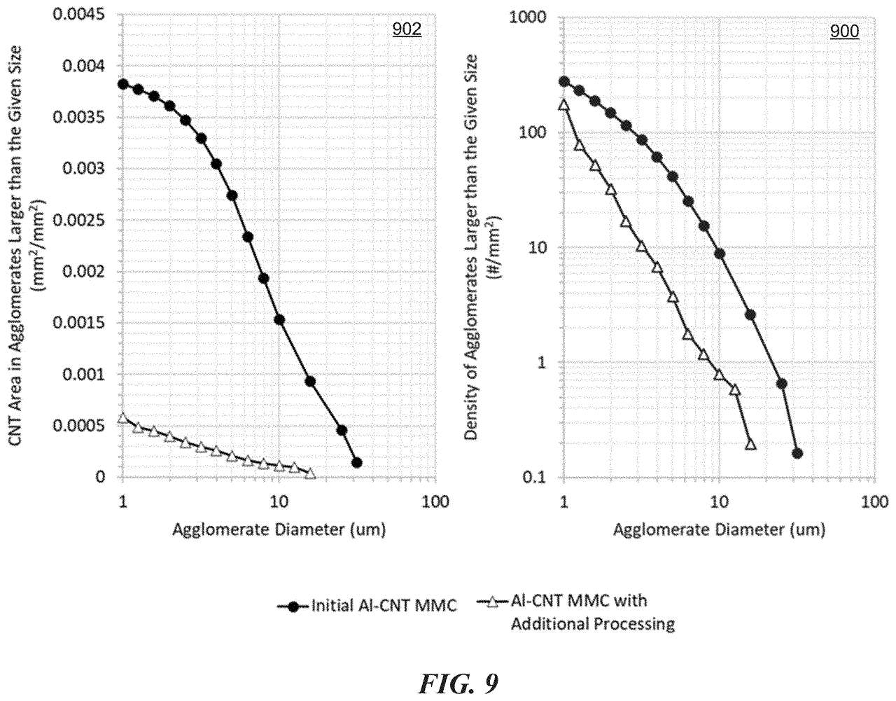

FIG. 9 shows two plots providing detailed information on the size and density of CNT aggregates in two MMCs each containing ˜0.5 wt % CNT. The plots illustrate results of an analysis conducted on samples cross-sectioned perpendicular to the direction of extrusion processing. This analysis shows that additional extrusion processing applied to Al-CNT MMCs with initially poor CNT distribution results in a significant reduction of cross-sectional area occupied by CNT aggregates, as well as a significant decrease in the density of aggregates larger than 1 μm diameter.

In particular, plot 900 of FIG. 9 shows that for aggregates larger than ˜10 μm in average diameter, the initial Al-CNT MMC has a number density of ˜10/mm² within the cross-sectioned area, whereas the Al-CNT MMC with additional processing has a number density of <1/mm² for such aggregates. As shown in plot 900 of FIG. 9, the total area fraction occupied by CNT aggregates with average diameters larger than ˜1 μm for the initial Al-CNT MMC is ˜0.0038 or 0.38%, whereas the total CNT aggregate area for the MMC with additional extrusion processing is ˜0.0005 or 0.05%.

The reduction in size and density of large CNT aggregates results in a more even distribution of the CNT within the Al matrix, providing substantial benefits to the mechanical properties and thermal stability of the composite. An even distribution can be defined by the overall area fraction or percent of CNT aggregates but also depends on the total CNT content in the MMC.

Thus, in one example, an Al-CNT MMC having an even distribution of CNT contains ˜0.5 wt % CNT and exhibits a CNT aggregate area percent of <0.38% for aggregates of average diameters ˜1 μm or greater. The aggregate area percent of said Al-CNT MMC is preferably <0.20%, and more preferably <0.10%, for aggregates of average diameter ˜1 μm or greater.

### Bending Behavior

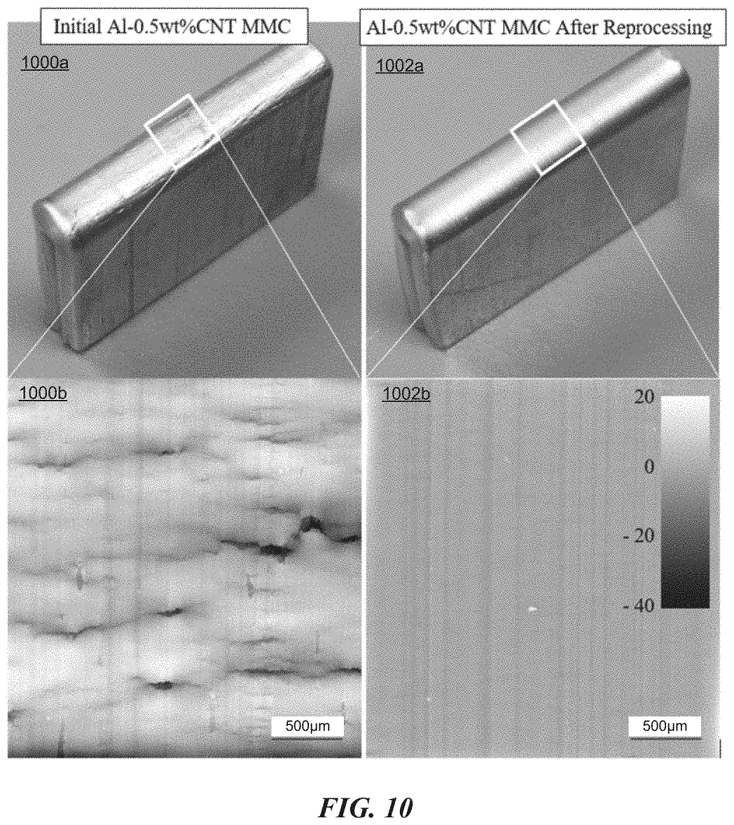

FIG. 10 includes images showing that bending behavior can also benefit from even distribution of CNTs in Al-CNT MMC busbars. More specifically, FIG. 10 shows images of Al-0.5 wt % CNT MMC busbars that are bent 180 degrees in the flatwise direction in soft condition (minimal residual stress). The images include a first busbar 1000a before an added extrusion step and a second busbar 1002a after an added extrusion step to achieve even distribution of CNT within the Al. From these images it is apparent that having even distribution of CNT improves bending behavior. While the first busbar 1000a that lacks even distribution of CNTs displays numerous cracks after 180 degree flatwise bending (see 1000b), the second busbar 1002a, identical to the first busbar 1000a other than the addition of an extrusion step to achieve even distribution of CNT, can complete the 180-degree bend without any observed crack propagation (see 1002b).

### Thermal Stability

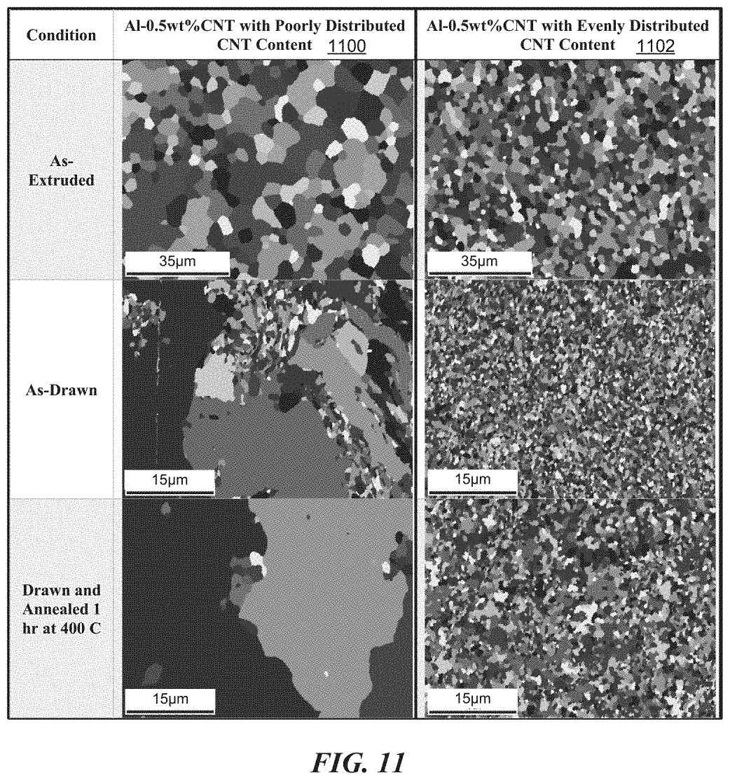

In addition to the aforementioned benefits, achieving even distribution of CNT within Al-CNT MMCs can increase thermal stability. For example, FIG. 11 depicts how heat treatment affects the grain size of a sample 1100 corresponding to cold-worked Al-0.5 wt % CNT MMC wire having an inferior distribution of CNT with numerous large aggregates, compared to a sample 1102 corresponding to different cold-worked Al-0.5 wt % CNT MMC wire with even distribution of CNT. Specifically, FIG. 11 shows unique grain electron backscatter diffraction (EBSD) images that illustrate the benefits of even CNT distribution in cold-worked Al-0.5 wt % CNT MMC wires. The sample 1100 with poor CNT distribution has a larger initial grain size that resulted in uneven and excessive grain growth upon cold working (drawing) and annealing. The sample 1102 with even CNT distribution has a smaller initial grain size and maintains a relatively consistent and homogenous grain size throughout the sample when subjected to the same cold working and heat treatment. In the sample 1100 with poorly dispersed CNT, grain growth occurs unchecked in some regions of the sample, while other areas resist this growth. This may be due to regions in the MMC with relatively low quantities or absence of CNT which have a similar thermal stability as that of pure Al. This phenomenon is not observed in the sample 1102 with evenly distributed CNT content (e.g., smaller/fewer CNT aggregates with the same C content).

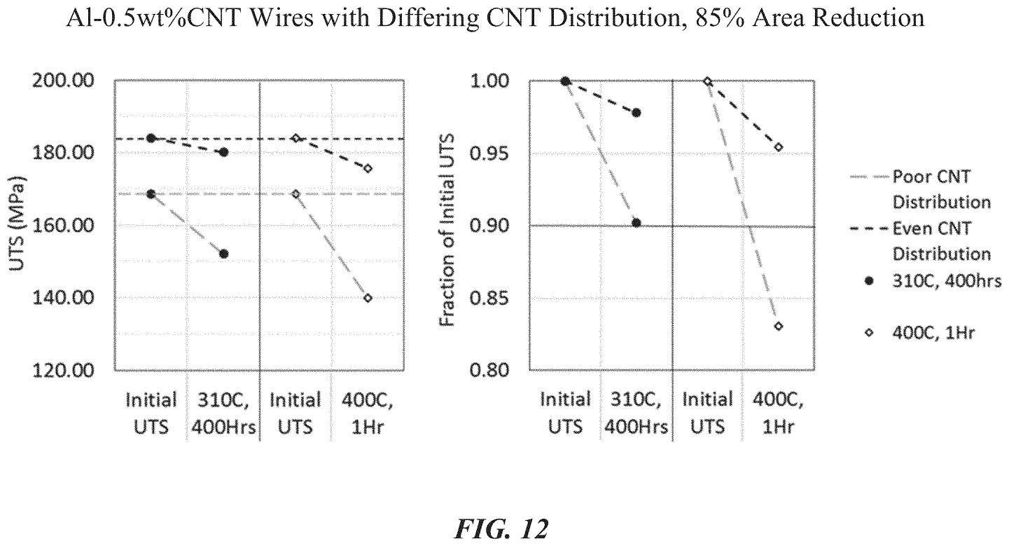

As a consequence of having internal regions where grains are free to grow without obstruction, the thermo-mechanical properties of an Al-0.5 wt % CNT sample 1100 with poorly dispersed CNT are significantly less thermally stable than the thermo-mechanical properties of an Al-0.5 wt % CNT sample 1102 with evenly distributed CNT. For example, FIG. 12 shows that an Al-CNT MMC with poor CNT distribution does not meet the AT4 criteria per IEC 62004, whereas samples with even CNT distribution do meet the AT4 criteria (see the previous Thermal Stability section and FIG. 7 for a description of the testing).

More specifically, the plots in FIG. 12 compare the thermal stability of drawn Al-0.5 wt % CNT MMC wires having poor CNT distribution with those having even CNT distribution. As in FIG. 7, samples need to maintain greater than 90% of their initial UTS after the specified heat treatments, to meet the thermal stability requirements for type AT4 material. The sample with poorly distributed CNT does not pass this metric. Thus, this comparison emphasizes the importance of breaking up CNT aggregates and having even distribution of CNTs in Al-CNT MMCs, for them to achieve their full potential.

### Embodiments

The disclosed embodiments include a busbar configured for electrical power distribution applications (e.g., an automotive application). The busbar can include an Al-MMC that has a concentration (e.g., amount) of nanoscale carbon particles. The concentration of the nanoscale carbon particles can be in a range of 0.01 to 2 weight percent (wt %), such as of 0.1 to 1 wt %, or such as of 0.2 to 0.8 wt %, or such as of 0.25 to 0.75 wt %, or such as of 0.4 to 0.6 wt %. The nanoscale carbon particles are evenly dispersed throughout an entirety of the Al-MMC.

The nanoscale carbon particles can include single-walled carbon nanotubes (CNTs), multi-walled CNTs, graphene nanoplatelets (GNPs), fullerenes, nanodiamonds, and/or nanoparticles with predominantly sp² or sp³ carbon. In one example, the nanoscale carbon particles include a mixture of particles selected from the group consisting of CNTs, GNPs, fullerenes, nanodiamonds, and nanoparticles with predominantly sp² or sp³ carbon.

In one example, the busbar can have a conductivity greater than 50% International Annealed Copper Standard (IACS), an ultimate tensile strength (UTS) greater than 80 MPa, and an elongation greater than 10%. For example, the busbar can have a conductivity greater than 50%, or greater than 55%, or greater than 58% IACS, a UTS greater than 120 MPa, and an elongation greater than 30%. Other ranges include a conductivity greater than 50%, or greater than 55%, or greater than 58% IACS, a UTS greater than 200 MPa, and an elongation greater than 1%. In yet another example, the busbar has a conductivity greater than 50%, or greater than 55%, or greater than 58% IACS, a UTS greater than 300 MPa, and an elongation greater than 3%.

The disclosed embodiments also include a process for achieving an even distribution of nanoscale carbon particles in an MMC component (e.g., an Al-C MMC busbar). The process can include obtaining an MMC feedstock material comprising a metal matrix and nanoscale carbon particles and processing the MMC feedstock material through a solid-state deformation process. As such, the MMC component can have an even distribution of the nanoscale carbon particles at a concentration range of 0.01 to 2 wt %, for example. Examples of the solid-state deformation process include an extrusion process and/or an ECAP process.

From the foregoing, it will be appreciated that specific embodiments of the invention have been described herein for purposes of illustration, but that various modifications may be made without deviating from the scope of the invention.

1. A busbar configured for an electrical power distribution application, the busbar comprising:
an aluminum (Al) metal matrix composite (MMC) comprising nanoscale carbon particles in a concentration of 0.01 to 2 percent by weight (wt %),
wherein the nanoscale carbon particles are evenly distributed throughout an entirety of the Al-MMC.

2. The busbar of claim 1, wherein the concentration of the nanoscale carbon particles is in a range of 0.1 to 1 wt %.

3. The busbar of claim 1, wherein the concentration of the nanoscale carbon particles is in a range of 0.2 to 0.8 wt %.

4. The busbar of claim 1, wherein the nanoscale carbon particles include single-walled carbon nanotubes (CNTs).

5. The busbar of claim 1, wherein the nanoscale carbon particles include multi-walled CNTs.

6. The busbar of claim 1, wherein the nanoscale carbon particles include graphene nanoplatelets (GNPs), fullerenes, nanodiamonds, or any combination thereof.

7. The busbar of claim 1, wherein the nanoscale carbon particles include nanoparticles with predominantly sp² or sp³ carbon.

8. The busbar of claim 1, wherein the nanoscale carbon particles are selected from the group consisting of:
CNTs,
GNPs,
fullerenes,
nanodiamonds,
nanoparticles with predominantly sp² or sp³ carbon, and
any combination thereof.

9. The busbar of claim 1, wherein the busbar has an electrical conductivity greater than 50% International Annealed Copper Standard (IACS), an ultimate tensile strength (UTS) greater than 80 MPa, and an elongation greater than 10%.

10. The busbar of claim 9, wherein the busbar has an electrical conductivity greater than 50% IACS, a UTS greater than 120 MPa, and an elongation greater than 30%.

11. The busbar of claim 1, wherein the busbar has an electrical conductivity greater than 50% IACS, a UTS greater than 200 MPa, and an elongation greater than 1%.

12. The busbar of claim 11, wherein the busbar has an electrical conductivity greater than 50% IACS, a UTS greater than 300 MPa, and an elongation greater than 3%.

13. The busbar of claim 1, wherein after heating the busbar either at 400° C. for 1 hour or at 310° C. for 400 hours, the UTS of the busbar is at least 90% of its UTS prior to heating.

14. The busbar of claim 1, wherein after creep testing for 100 hours at 150° C. with an applied load of 80% of its room-temperature yield strength, the busbar shows a total displacement of less than 5%.

15. The busbar of claim 14, wherein after creep testing for 500 hours at 150° C. with an applied load of 80% of its room-temperature yield strength, the busbar shows a total displacement of less than 5%.

16. The busbar of claim 1, wherein the electrical power distribution application is an automotive application.

17. The busbar of claim 16, wherein the busbar has a total carbon content of up to about 0.5 wt % and an even distribution of carbon, in which the total area fraction of carbon particles larger than about 1 μm is less than about 0.38%.

18. A process for achieving even distribution of nanoscale carbon particles throughout an entirety of a metal matrix composite (MMC) component, the process comprising:
obtaining a metal matrix composite (MMC) feedstock material comprising a metal matrix and nanoscale carbon particles; and
processing the MMC feedstock material through a solid-state deformation process to form the MMC component with even distribution of the nanoscale carbon particles throughout an entirety of the MMC component.

19. The process of claim 18, wherein the solid-state deformation process comprises an extrusion process.

20. The process of claim 18, wherein the solid-state deformation process comprises an equal channel angular pressing (ECAP) process.

21. The process of claim 18, wherein the MMC feedstock material is an aluminum (Al) MMC feedstock material.
